(19) United States
(12) Patent Application Publication
(10) Pub. No.: US 2026/0149352 A1
(43) Pub. Date: May 28, 2026

(54) ZERO-VOLTAGE SOFT SWITCHING CONTROL METHOD AND POWER CONTROL CIRCUIT USING THE SAME

(71) Applicants: Nanyang Technological University, Singapore (SG); LITE-ON SINGAPORE PTE. LTD., Singapore (SG)

(72) Inventors: Zhigang YAO, Singapore (SG); Yi TANG, Singapore (SG); Jing YANG, Singapore (SG); Shih-Ming CHEN, Taipei (TW); Yi Chyn Cassandra WONG, Singapore (SG)

(21) Appl. No.: 19/082,882

(22) Filed: Mar. 18, 2025

Related U.S. Application Data
(60) Provisional application No. 63/724,502, filed on Nov. 25, 2024.

(51) Int. Cl. H02M 1/00; H02M 7/217; H02M 7/537

(52) U.S. Cl. CPC H02M 1/0058; H02M 7/217; H02M 7/537

(57) ABSTRACT

A zero-voltage soft switching (ZVS soft switching) control method and a power control circuit using the same are provided. The ZVS shot switching control method includes the following steps. A trapezoidal current control is executed to shape an inductor current into a plurality of trapezoidal waveforms.

This application claims the benefit of Unite State Provisional application Ser. No. 63/724,502, filed Nov. 25, 2024, the disclosure of which is incorporated by reference herein in its entirety.

### TECHNICAL FIELD

The disclosure relates in general to a control method and a circuit using the same, and more particularly to a zero-voltage soft switching (ZVS soft switching) control method and a power control circuit using the same.

### BACKGROUND

In power electronics, AC-DC and DC-AC converters are essential circuit topologies used to convert alternating current (AC) to direct current (DC) and vice versa. These converters are widely employed in applications such as power factor correction (PFC) rectifiers, photovoltaic inverters, battery energy storage systems, and electric vehicle chargers. As the demand for high efficiency, compact size, and higher voltage capabilities increases, multilevel inverters and multilevel PFC Rectifiers have been developed to reduce the size of inductors and capacitors and decrease voltage stress on power semiconductors. Examples of such converters include flying-capacitor multilevel converters, cascaded H-bridge multilevel converters, and neutral-point-clamped multilevel converters, which have been successfully developed to meet market demands. Additionally, by employing multilevel techniques, electromagnetic interference (EMI) is significantly reduced, enabling the use of smaller EMI filters in the converters.

### SUMMARY

The disclosure is directed to a zero-voltage soft switching (ZVS soft switching) control method and a power control circuit using the same to achieve the ZVS soft-switching without the need for additional auxiliary circuits or components. In the proposed ZVS soft switching control method, specific output voltage-level sequences are used, such that the inductor current forms a trapezoidal waveform with both positive peak values and negative peak values in each switching cycle. This approach not only reduces switching losses by enabling ZVS soft switching operation but also decreases the current stress on the switches by lowering the peak values of the inductor current.

According to one embodiment, a zero-voltage soft switching (ZVS soft switching) control method for a power control circuit is provided. The ZVS soft switching control method includes the following steps. A trapezoidal current control is executed to shape an inductor current into a plurality of trapezoidal waveforms.

According to another embodiment, a power control circuit is provided. The power control circuit includes a trapezoidal current control unit. The trapezoidal current control unit is configured to shape an inductor current into a plurality of trapezoidal waveforms.

### BRIEF DESCRIPTION OF THE DRAWINGS

FIG. 1 shows an inductor current controlled under a ZVS soft switching control method based on a trapezoidal current mode (TZCM).

FIG. 2 illustrates the ZVS soft switching control method based on the trapezoidal current mode for multilevel DC-AC converters.

FIG. 3 shows a trapezoidal current modulation scheme I of the ZVS soft switching control method for the power control circuit.

FIG. 4 shows a trapezoidal current modulation scheme II of the ZVS soft switching control method for the power control circuit.

FIG. 5 shows an example of a five-level inverter or PFC rectifier topology and its trapezoidal waveform.

FIG. 6 shows an example of a nine-level inverter or PFC rectifier topology consisting of a half-bridge and a flying-capacitor five-level bridge.

FIG. 7 shows an example of a five-level inverter or PFC rectifier topology consisting of two flying-capacitor three-level bridges.

FIG. 8 shows an example of a five-level inverter or PFC rectifier topology consisting of two T-type three-level bridges.

FIG. 9 shows an example of a cascaded inverter or PFC rectifier topology and its trapezoidal waveforms.

FIG. 10 illustrates a three-phase flying-capacitor multilevel inverter or PFC rectifier topology along with its inductor current waveforms.

FIG. 11 illustrates that the converter operates at the level sequence of “3-2-1” by outputting special switching states of eight high-frequency switches.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

In one embodiment, multilevel inverters and multilevel PFC Rectifiers could operate in continuous conduction mode (CCM), which leads to hard-switching operations and results in significant switching losses. To reduce the switching loss, soft-switching techniques could be used in the converters, particularly zero-voltage soft switching (ZVS soft switching). ZVS soft switching is an effective method to eliminate turn-on and diode reverse recovery losses, allowing for operation at higher switching frequencies without excessive switching losses. Higher switching frequencies also enable the design of more compact and lightweight converters with improved dynamic response and reduced passive component sizes. Additionally, when switches operate with the ZVS soft switching, the dv/dt slope of voltage waveforms is mitigated, leading to reduced EMI emissions. In summary, ZVS soft-switching plays a crucial role in multilevel converters by reducing switching losses, improving converter efficiency, and minimizing EMI.

In some methods for achieving ZVS soft-switching, additional auxiliary components and circuits are required for multilevel inverters and multilevel PFC Rectifiers. These components increase the converter's size, cost, and hardware complexity. To eliminate the need for auxiliary circuits and components, a triangular current mode (TCM) is used to achieve ZVS soft switching by increasing the inductor current ripple. Normally, in the TCM, the peak inductor current exceeds twice the average current value, which increases current stress and turn-off losses of the power switch.

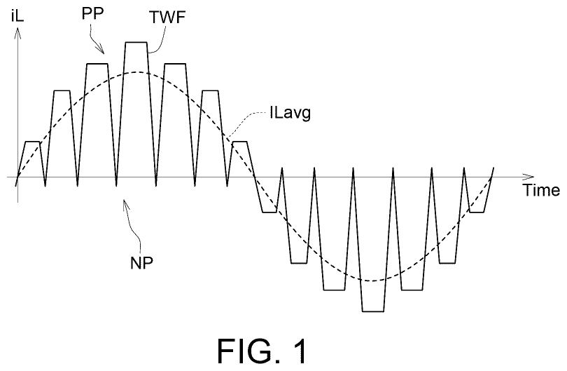

Please refer to FIG. 1. FIG. 1 shows the inductor current iL controlled under a ZVS soft-switching control method based on a trapezoidal current mode (TZCM).

In some embodiments, multilevel inverters and multilevel PFC rectifiers operate in either the continuous conduction mode (CCM) with hard-switching, or the triangular current mode (TCM) with zero-voltage switching. Both CCM and TCM have a triangular inductor current waveform. In particular, the peak inductor current in TCM is more than twice the average current value.

In the embodiment shown in the FIG. 1, the ZVS soft-switching control method based on the trapezoidal current mode (TZCM) for multilevel inverters and multilevel PFC rectifiers is developed to realize all high-frequency switches in the ZVS soft switching, in order to reduce switching losses and EMI interference of the converter.

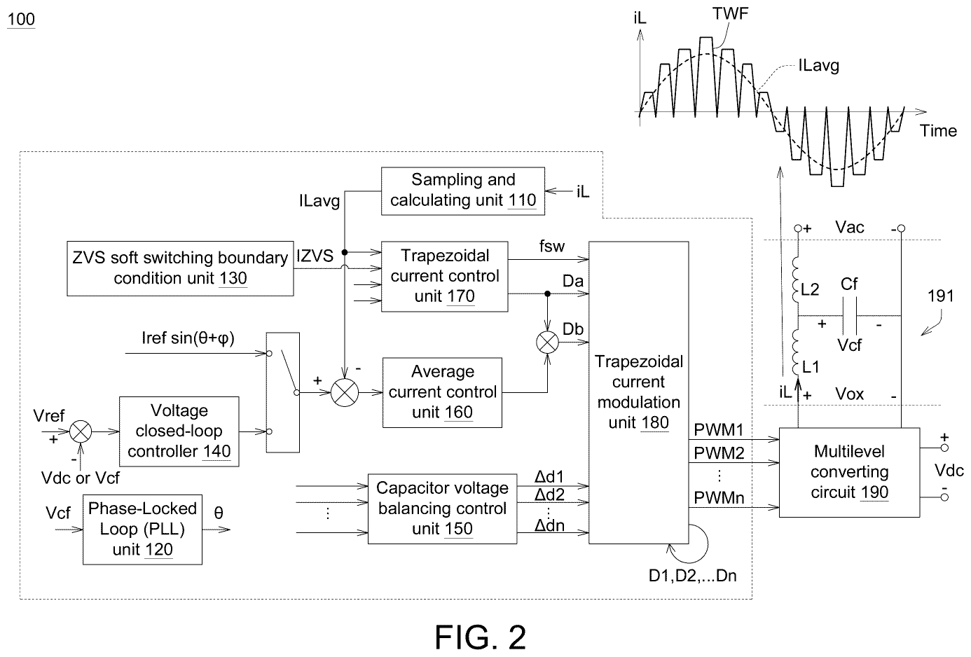

Please refer to FIG. 2. FIG. 2 illustrates the ZVS soft switching control method based on the trapezoidal current mode for multilevel DC-AC converters, where the inductor current iL has a trapezoidal shape with the sinusoidal average current values ILavg. The present technology could be applied to any bi-directional power converter, such as AC-DC or DC-AC converters. Both DC and AC can be considered as the input port. The DC-AC converter shown in the FIG. 2 is just used as an example.

The ZVS soft switching control method based on the trapezoidal current mode could be applied to a multilevel AC-DC converter, such as a multilevel PFC rectifier and a multilevel DC-AC converter, such as a multilevel inverter, as shown in FIG. 2. By using this zero-voltage soft switching (ZVS soft switching) control method to generate specific output voltage-level sequences, the inductor current iL adopts a trapezoidal shape with the sinusoidal average current value ILavg. In each switching cycle, the inductor current iL forms a trapezoidal waveform TWF, referred to as Trapezoidal Current Mode (TZCM). Because the trapezoidal inductor current iL exhibits both the positive values PV and the negative peak values NV within each switching cycle, the converter can achieve the ZVS soft-switching. As a result, the ZVS soft switching control method based on the trapezoidal current mode not only achieves the ZVS soft switching but also reduces the peak and RMS inductor currents compared to the triangular current mode (TCM). Therefore, the ZVS soft switching control method based on the trapezoidal current mode can realize a high-efficiency AC-DC or DC-AC converter suitable for various PFC rectifiers or inverters. The present embodiment is proposed to develop a control and modulation method to generate specific voltage levels and sequences, enabling multilevel rectifiers or inverters to operate in TZCM, thereby benefiting from the ZVS soft switching and reduced peak currents. The ZVS soft switching control method based on the TZCM is not limited to a single circuit topology; it could be applied to any type of AC-DC or DC-AC multilevel converter, such as flying capacitor, T-type, or cascaded H-bridge topologies.

The ZVS soft switching control method based on the trapezoidal current mode (TZCM) is, for example, implemented in a DSP controller or a FPGA controller of the power control circuit 100. The power control circuit 100 includes, for example, a sampling and calculating unit 110, a Phase-Locked Loop (PLL) unit 120, a ZVS soft switching boundary condition unit 130, a voltage closed-loop controller 140, a capacitor voltage balancing control unit 150, an average current control unit 160, a trapezoidal current control unit 170, a trapezoidal current modulation unit 180, a multilevel converting circuit 190 and a filter circuit 191. The filter circuit 191 includes, for example, an inductor L1, an inductor L2 and a capacitor Cf.

The trapezoidal current control unit 170, the average current control unit 160 and the capacitor voltage balancing control unit 150 are respectively used to execute three main control loops, including a trapezoidal current control, an average current control, and a capacitor voltage balancing control.

The trapezoidal current control unit 170 is configured to shape the inductor current iL into the trapezoidal waveforms TWF. The average current control unit 160 is configured to make the inductor current iL has the sinusoidal average current value ILavg. The capacitor voltage balancing control unit 150 is configured to maintain capacitor voltages.

In detail, the implementation of the ZVS soft switching control method could be divided into the following steps.

(1) The sampling and calculating unit 110 samples the DC-side voltage Vdc, the AC-side voltage Vcf or Vac, and calculates the average current value ILavg of the trapezoidal inductor current iL.

(2) The Phase-Locked Loop unit 120 calculates the AC voltage angle θ and the ZVS soft switching boundary condition unit 130 selects the reverse current value IZVS based on the ZVS soft switching boundary condition.

(3) The voltage closed-loop controller 140 executes the outer loop voltage control for the DC-side voltage Vdc (for the PFC rectifiers) or the AC-side voltage Vcf (for the inverters), and the capacitor voltage balancing control unit 150 executes the capacitor voltage balancing control to maintain the desired flying-capacitor or series-capacitor voltage.

(4) The average current control unit 160 executes the inner loop average current control to achieve the desired average current value ILavg, and the trapezoidal current control unit 170 executes the trapezoidal current control to shape the inductor current iL into the trapezoidal waveforms TWF with the reverse peak current compared to the average current value ILavg. In this step, the duty cycles Da, Db and the switching frequency fsw could be obtained, and combined with the compensation duty cycles Δd1, Δd2, . . . , Δdn from the capacitor voltage balancing control to calculate the duty cycles D1, D2, . . . , Dn of the main switches.

(5) The trapezoidal current modulation unit 180 executes the trapezoidal current modulation and cyclically alternates these duty cycles D1, D2, . . . , Dn to generate Pulse-Width Modulation (PWM) signals PWM1, PWM2, . . . , PWMn.

(6) These PWM control signals PWM1, PWM2, . . . , PWMn are applied to control the gates of power switches using driver IC chips, ultimately shaping the inductor current iL into varied trapezoidal waveforms TWF with sinusoidal average current value ILavg.

The inductor current iL with the trapezoidal waveforms TWF is modulated based on a level sequence of an output voltage Vox, the duty cycles Da, Db and the switching frequency fsw. There are at least two different trapezoidal current modulation schemes of the ZVS soft switching control method.

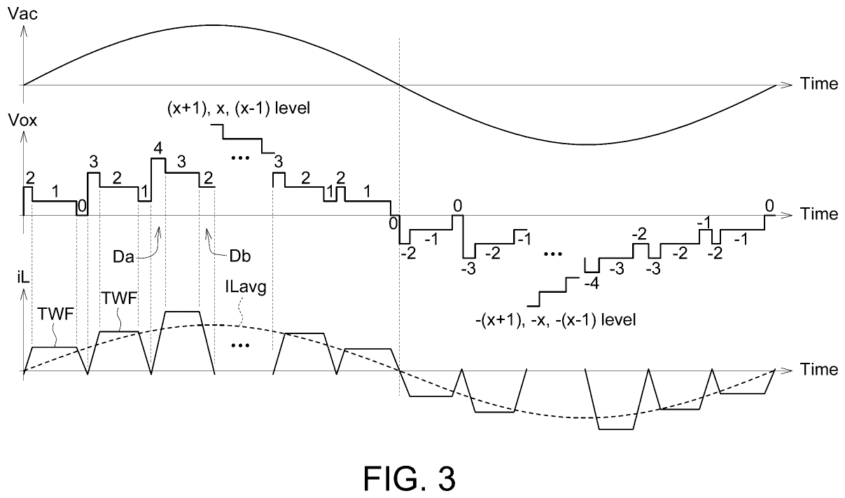

Please refer to FIGS. 2 and 3. FIG. 3 shows a trapezoidal current modulation scheme I of the ZVS soft switching control method for the power control circuit 100, such as the multilevel inverters. The FIGS. 2 and 3 use the multilevel inverters as an example to illustrate the present disclosed technology, but those figures are not used to limit the present disclosed technology. In the example of the multilevel inverters shown in the FIGS. 2 and 3, the power flows from the DC side to the AC side, and the AC-side voltage Vac and the inductor current iL are in the same phase. On the other hand, in another example of the multilevel PFC rectifiers, the power flows from the AC side to the DC side, and the AC-side voltage Vac and the inductor current iL are in the opposite phase.

As shown in the FIG. 3, when the AC-side voltage Vac is positive, the output voltage Vox contains a level sequence of “(x+1), x, (x−1)”, such as “2-1-0”, “3-2-1” and “4-3-2” level sequence. When the AC-side voltage Vac is negative, the output voltage Vox contains a level sequence of “−(x+1), −x, −(x−1)”. The level sequence of “(x+1), x, (x−1)” and the level sequence of “−(x+1), −x, −(x−1)” are used to produce the approximate trapezoidal waveform TWF. The x-level could be determined according to the below equation (1).

$$x = round ( \frac{\vert {V}_{ac} \vert}{{V}_{dc}} N ) \qquad ( 1 )$$

The round( ) function is a rounding function, such as round(0.4)=0 and round(0.6)=1.

For this modulation scheme I, the x-level is discretely changing, while the duty cycles Da and Db are continuously changing to adjust the shape of the trapezoidal inductor current iL, where the ultimate goal is to make the inductor current in TZCM to realize the ZVS soft switching of the converter. Additionally, the switching frequency fsw could also be changed to adjust the magnitude of the trapezoidal inductor current. The duty cycles Da and Db could be determined according to the below equation (2).

$$\frac{{D}_{a} ( x + 1 ) + ( 1 - {D}_{a} - {D}_{b} ) x + {D}_{b} ( x - 1 )}{N} = \frac{\vert {V}_{ac} \vert}{{V}_{dc}} \qquad ( 2 )$$

x is the output x-level of vox, N is the maximum number of positive voltage levels, such as N=3 for 7-level (−3, −2, −1, 0, 1, 2, 3) AC-DC rectifier or DC-AC inverter. Da is the duty cycle of the first level (i.e., x+1 level), Db is the duty cycle of the third level (i.e., x−1 level).

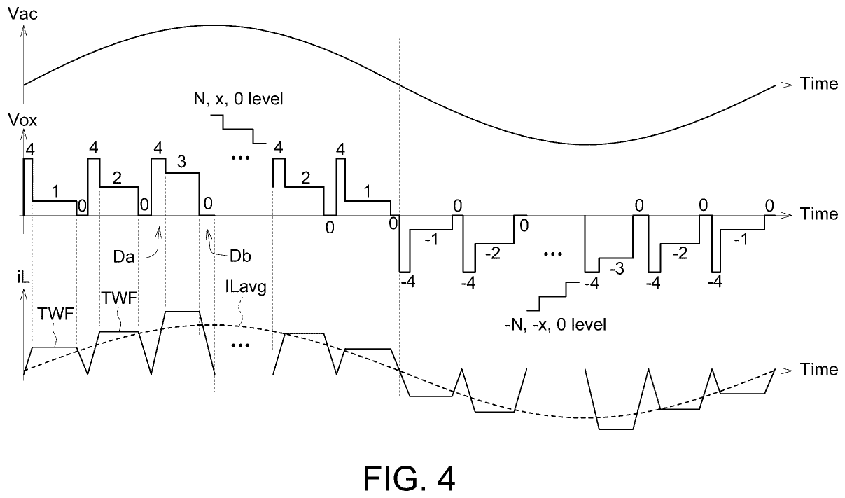

Please refer to FIG. 4. FIG. 4 shows a trapezoidal current modulation scheme II of the ZVS soft switching control method for the power control circuit 100, such as the multilevel inverters or the multilevel PFC rectifiers. When AC-side voltage Vac is positive, the output voltage Vox contains a level sequence of “N, x, 0”, such as “4-1-0” and “4-2-0” level sequence. When the AC-side voltage Vac is negative, the output voltage Vox contains a level sequence of “−N, −x, 0”. The level sequence of “N, x, 0” and the level sequence of “−N, −x, 0” are used to produce an approximate trapezoidal inductor current waveform. x is changed to adjust the inductor current iL. The x-level can be determined by using the equation (1).

For this modulation scheme II, the x-level is also discretely changing, while the duty cycles Da and Db are continuously changing to adjust the shape of the trapezoidal inductor current to make the inductor current in TZCM to realize the ZVS soft switching of the converter. Additionally, the switching frequency fsw could also be changed to adjust the magnitude of the trapezoidal inductor current. The duty cycles Da and Db could be determined according to the below equation (3).

$$\frac{{D}_{a} N + ( 1 - {D}_{a} - {D}_{b} ) x}{N} = \frac{\vert {V}_{ac} \vert}{{V}_{dc}} \qquad ( 3 )$$

By combining with the compensation duty cycles Δd1, Δd2, . . . , Δdn from the capacitor voltage balancing control, the duty cycles D1, D2, . . . , Dn of the main switches could be calculated according to the equation (4).

$${D}_{i} = Δ {d}_{i} + \{ \begin{matrix}{D}_{a} , & i < x \\ 1 - {D}_{b} , & i \geq x\end{matrix} , i = 1 , 2 , … , N \qquad ( 4 )$$

The duty cycles D1, D2, . . . , Dn are modulated to generate the PWM control signals PWM1, PWM2, . . . , PWMn that act on the gate of the power switches. Meanwhile, the PWM control signals PWM1, PWM2, . . . , PWMn generated by the duty cycles D1, D2, . . . , Dn are sequentially applied alternately to the main switch.

The ZVS soft switching control method based on the TZCM in the FIG. 2 could be applied to various multilevel AC-DC or DC-AC converters. And the modulation schemes I, II, as shown in FIG. 3 and FIG. 4, to achieve the trapezoidal current mode are same for various multilevel AC-DC or DC-AC converters.

As shown in the FIGS. 3, and 4, two of the trapezoidal waveforms TWF which are adjacent have different average current values ILavg. Further, each of the trapezoidal waveforms TWF sequentially has three stages, middle of the stages is flattest.

Moreover, as shown in the FIGS. 3 and 4, the output voltage Vox contains different duty cycles Da for different switch cycles and contains different duty cycles Da for different switch cycles. The duty cycles Da, Db are continuously changed to adjust the shape of the inductor current iL.

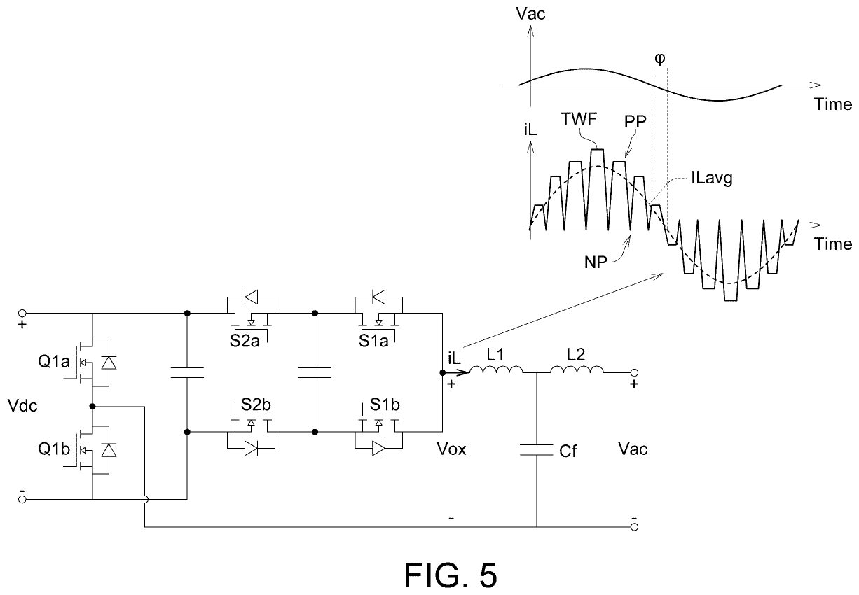

Please refer to FIG. 5, which shows an example of a five-level inverter or PFC rectifier topology and its trapezoidal waveform TWF. The switches Q1a, Q1b are operated at low frequency, when the AC-side voltage Vac is larger than 0, the switch Q1a is turned off and the switch Q1b is turned on. The switches S1a, S1b, S2a, S2b are operated at high frequency. The switches S1a, S2a are main switches. The switches S1a and S1b, as well as the switches S2a and S2b, function as complementary switches. This converter can generate five voltage-levels: −2, −1, 0, 1, 2. By using the ZVS soft switching control method based on the TZCM in FIG. 2, the inductor current iL consists of multiple trapezoidal waveforms TWF with the sinusoidal average current value ILavg. The trapezoidal inductor current iL has positive peak values PP and negative peak values NP during each switching cycle so that all switches could realize the ZVS soft switching. The output voltage Vox of this converter could be obtained as a level sequence of “(x+1), x, (x−1)” and “−(x+1), −x, 1(x−1)” by using the modulation scheme I in the FIG. 3, or could be obtained as a level sequence of “N, x, 0” and “−N, −x, 0” using the modulation II in the FIG. 4. x is changed to adjust the inductor current iL.

In addition, the phase angle φ between the inductor current iL with the average current value ILavg and the AC-side voltage Vac is adjustable, so that the multilevel inverter using the ZVS soft switching control method could flexibly regulate the active power and reactive power. For the PFC rectifier, the phase angle φ between the inductor current iL with the average current value ILavg and the AC-side voltage Vac is 0 to achieve the unit power factor.

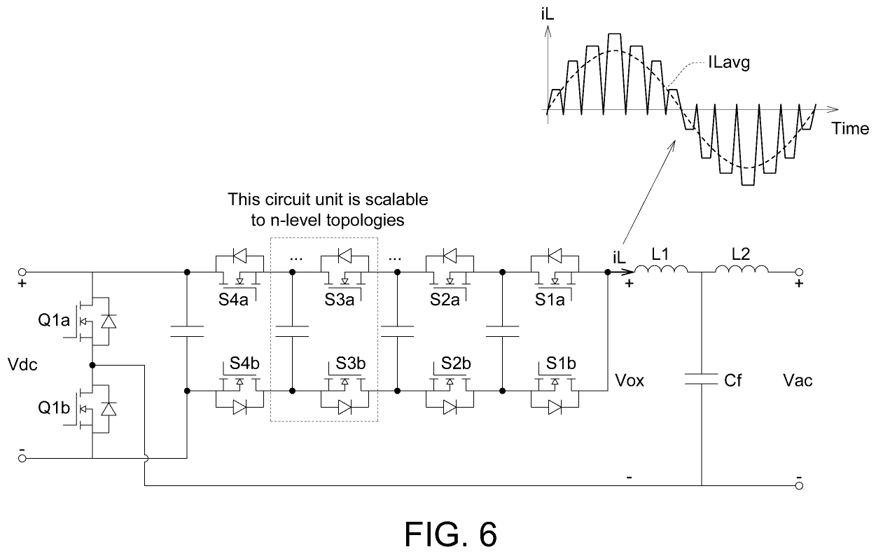

Please refer to FIG. 6. FIG. 6 shows an example of a nine-level inverter or PFC rectifier topology consisting of a half-bridge and a flying-capacitor five-level bridge, which can generate nine voltage-levels: −4, −3, −2, −1, 0, 1, 2, 3, 4. The switches Q1a, Q1b are operated at low frequency. When the AC-side voltage Vac is larger than 0, the switch Q1a is turned off and the switch Q1b is turned on. The switches S1a to S4b are operated at high frequency. Applying the ZVS soft switching control method based on the TZCM in the FIG. 2 and the modulation schemes I, II in the FIG. 3 and FIG. 4, the inductor current iL could be controlled into the trapezoidal waveforms TWF with the sinusoidal average current value ILavg by setting the suitable output voltage-level sequence. This topology is possible to extend to n-level flying-capacitor inverter or rectifier. All switches in this converter could also realize the ZVS soft switching during each switching cycle.

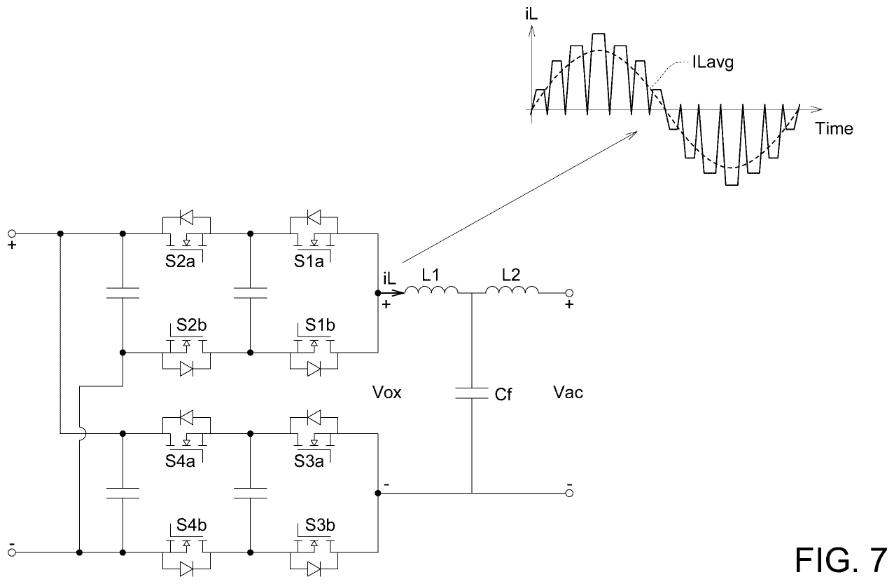

Please refer to FIG. 7. FIG. 7 shows an example of a five-level inverter or PFC rectifier topology consisting of two flying-capacitor three-level bridges, which is capable of generating five voltage-levels: −2, −1, 0, 1, 2. The switches Q1a, Q1b are operated at low frequency. When the AC-side voltage Vac is larger than 0, the switch Q1a is turned off and the switch Q1b is turned on. Other eight switches S1a to S4b are operated at high frequency. The switches S1a, S2a, S3a, S4a serve as the main switches. By using the ZVS soft switching control method based on the TZCM in the FIG. 2, along with the modulation scheme I in the FIG. 3, the inductor current iL could be regulated into multiple trapezoidal waveforms TWF with the sinusoidal average current value ILavg. The trapezoidal inductor current iL exhibits the positive peak values PP and the negative peak values NP during each switching cycle, enabling all switches to achieve the ZVS soft switching.

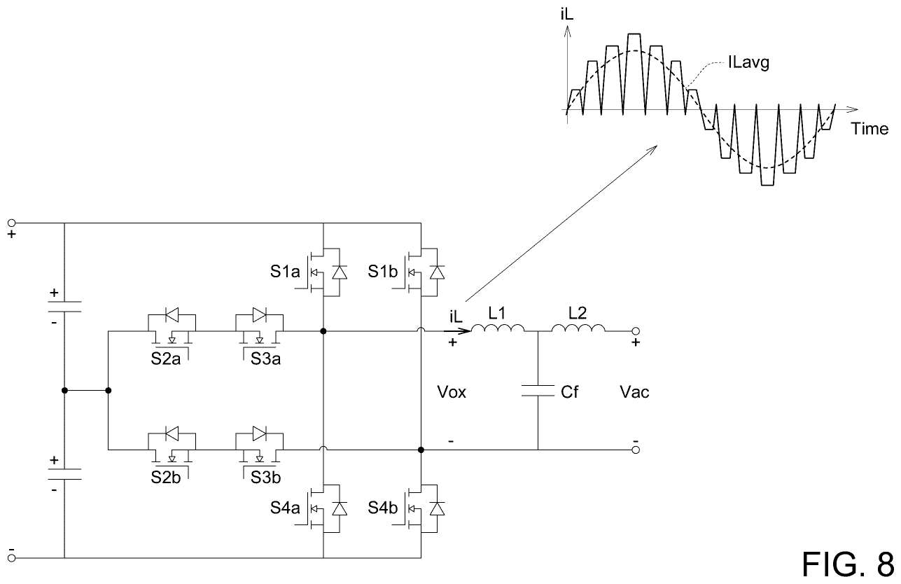

Please refer to FIG. 8. FIG. 8 shows an example of a five-level inverter or PFC rectifier topology consisting of two T-type three-level bridges, which is also capable of generating five voltage-levels: −2, −1, 0, 1, 2. All eight switches S1a to S4b are operated at high frequency. By using the ZVS soft switching control method based on the TZCM in the FIG. 2, along with the modulation scheme I in the FIG. 3, the inductor current iL could be regulated into multiple trapezoidal waveforms TWF with the sinusoidal average current value ILavg. The trapezoidal inductor current iL exhibits the positive peaks values PP and the negative peak values NP during each switching cycle, enabling all switches to achieve the ZVS soft switching.

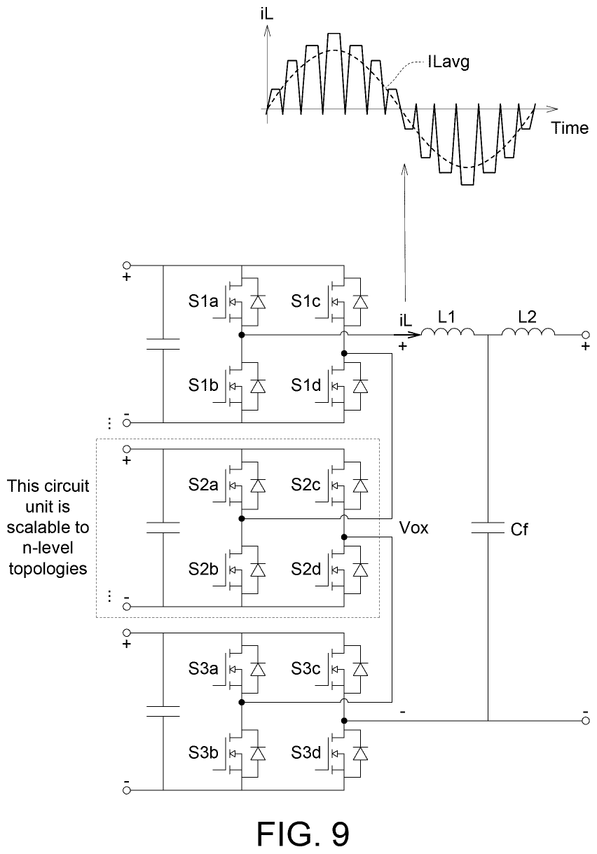

For another class of multilevel topology cascaded H-bridge, the ZVS soft switching control method based on the TZCM could also be used to realize the ZVS soft switching. FIG. 9 shows an example of a cascaded inverter or PFC rectifier topology and its trapezoidal waveforms TWF. All twelve switches S1a to S3d are operated at high frequency, which is also capable of generating five voltage-levels: −3, −2, −1, 0, 1, 2, 3. Similarly, by using the ZVS soft switching control method based on the TZCM in the FIG. 2, along with the modulation scheme I in the FIG. 3, the inductor current iL could be regulated into multiple trapezoidal waveforms TWF with a sinusoidal average current value ILavg. The trapezoidal inductor current iL exhibits the positive peak values PP and the negative peak values NP during each switching cycle, enabling all switches to achieve the ZVS soft switching.

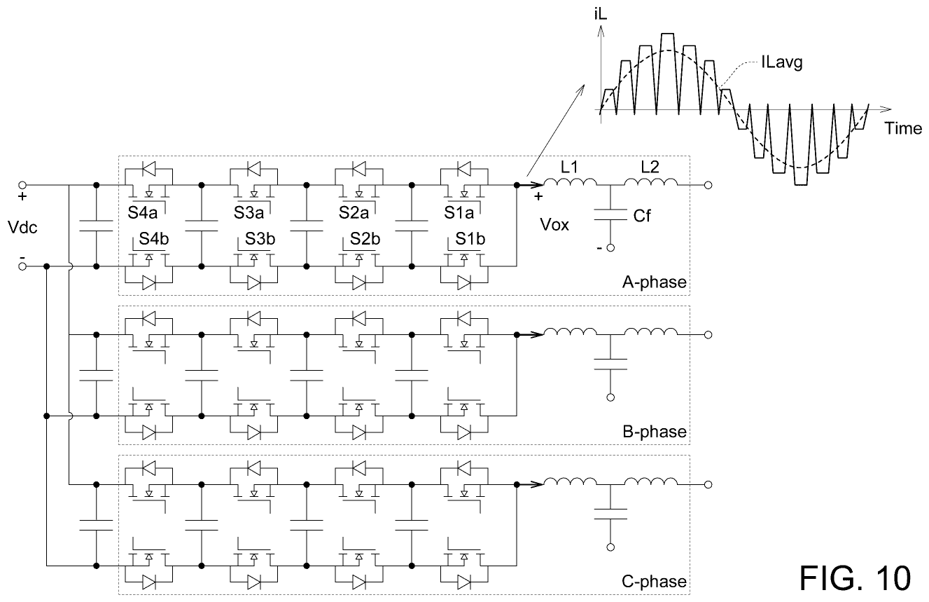

In addition, the ZVS soft switching control method based on the TZCM, as shown in the FIG. 2, and the modulation scheme I in the FIG. 3 or the FIG. 4, could also be applied to three-phase multilevel inverter or PFC rectifier. For instance, FIG. 10 illustrates a three-phase flying-capacitor multilevel inverter or PFC rectifier topology along with its inductor current waveforms. The B-phase and C-phase have the same hardware configuration as the A-phase. The ZVS soft switching control method based on the TZCM in the FIG. 2 is applied to the A-phase, B-phase, and C-phase respectively, with the phase angles of the current and voltage for the A-phase, B-phase, and C-phase being 0°, 120°, and 240°, respectively.

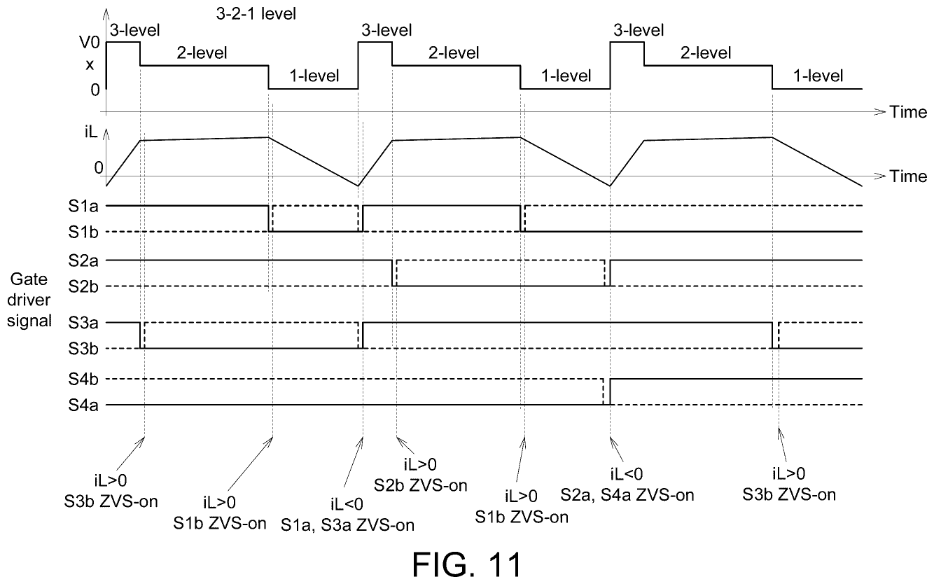

All high-frequency switches of the multilevel inverters or PFC rectifiers could realize the ZVS soft-switching by utilizing the ZVS soft switching control method based on the TZCM in FIG. 2. Taking the converter circuit from the FIG. 6 as an example, when the AC-side voltage Vac is larger than 0 (the switch Q1a is turned off and the switch Q1b is turned on) and x=2, the converter operates at the level sequence of “3-2-1” by outputting special switching states of eight high-frequency switches, as shown in FIG. 11. When the valley inductor current iL is lower than 0, the inductor current iL flows through the body diodes of the four main switches S1a, S2a, S3a, S4a during the deadtime, so the voltages of these four switches are zero. Thus, when the four switches S1a, S2a, S3a, S4a are turned on at the negative valley inductor current iL, they could realize the ZVS-on soft-switching. Due to the special modulation I in the FIG. 3, the level sequence of “3-2-1” is generated alternately by three switches of all four main switches. So, at the first valley inductor current iL, the switch S1a and the switch S3a realize the ZVS-on soft switching, while the switch S2a and the switch S4a realize the ZVS-on soft switching at the second valley inductor current iL.

Similarly, when the peak inductor current iL is larger than 0, the four switches S1b, S2b, S3b, S4b could realize the ZVS-on soft switching soft-switching at turning-on moment.

The present disclosure is not limited to a single circuit topology; it can be applied to various multilevel inverter and PFC rectifier circuit topologies, such as flying capacitor, T-type, or cascaded H-bridge multilevel topologies. These topologies are widely used in PFC rectifiers or inverters that require conversion between AC and DC power, such as in photovoltaic power generation, wind power generation, battery energy storage systems, server power supplies, and electric vehicle chargers. By implementing the present disclosure, the multilevel inverters or PFC rectifiers could achieve ZVS soft-switching, which reduces switching losses and EMI, thereby improving converter efficiency.

In brief, the ZVS soft switching control method and the power control circuit 100 using the same has novelty and at least includes the following features.

The inductor current iL consists of multiple trapezoidal waveforms TWF with the sinusoidal average current value ILavg. The trapezoidal inductor current iL exhibits both the positive peak values PP and the negative peak values NP during each switching cycle.

The ZVS soft switching control method integrates the trapezoidal current control, the average current control, and the capacitor voltage balancing control. This method is implemented by adjusting the output voltage-level sequence, the duty cycles Da, Db, and the switching frequency fsw. With this control approach, multilevel inverters and multilevel PFC rectifiers could operate in the TZCM to achieve the ZVS soft-switching.

Two types of trapezoidal current modulation schemes I, II have been developed to generate the appropriate voltage-level sequence. The voltage-level sequence could be produced by a subset or all of the switches, while alternating the voltage levels to help balance capacitor voltages.

Controlling multilevel inverters and multilevel PFC rectifiers in the TZCM enables all high-frequency switches to achieve the ZVS soft switching without the need for auxiliary components or circuits. Consequently, this ZVS soft switching control method reduces switching losses and minimizes EMI interference in the converter.

The ZVS soft switching control method based on the TZCM is used for multilevel inverters and multilevel PFC rectifiers to ensure that all high-frequency switches operate in the ZVS soft switching, thereby reducing switching losses and minimizing EMI interference in the converter. The ZVS soft switching control method and the power control circuit 100 using the same at least includes the following advantages and improvements.

The ZVS soft switching control method is provided for multilevel inverters and multilevel PFC rectifiers to enable all high-frequency switches to achieve the ZVS soft switching without the need for auxiliary components or circuits. The topology of the circuit remains the same as before, but the operation mode of these converters has been changed to the TZCM so that the inductor current iL becomes multiple trapezoidal waveforms TWF with the sinusoidal average current value ILavg.

The continuous conduction mode (CCM) for multilevel inverters and multilevel PFC rectifiers operates in hard-switching state, resulting switching losses in significant and electromagnetic interference problems. Although the other existing method triangular current mode (TCM) could achieve the zero-voltage switching, the peak inductor current is more than twice the average inductor current, aggravating the current stress and turn-off losses of the power switch. The multilevel inverters and multilevel PFC rectifiers in both CCM and TCM have a triangular inductor current waveform.

In the present disclosure, the inductor current iL consists of multiple trapezoidal waveforms TWF with the sinusoidal average current value ILavg. Compared to the control methods based on the CCM, the proposed ZVS soft switching control method ensures that all high-frequency switches operate in the ZVS soft switching, thereby reducing switching losses and minimizing EMI interference in the converter. Additionally, compared to the control method based on the TCM, the proposed ZVS soft switching control method has a lower peak current and RMS current for the same average current ILavg. By implementing the ZVS soft switching and reducing the peak turn-off current, the electromagnetic interference problems are also mitigated compared to CCM and TCM.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A zero-voltage soft switching (ZVS soft switching) control method for a power control circuit, comprising:
executing a trapezoidal current control to shape an inductor current into a plurality of trapezoidal waveforms.

2. The ZVS soft switching control method for the power control circuit according to claim 1, further comprising:
executing an average current control to make the inductor current has a sinusoidal average current value.

3. The ZVS soft switching control method for the power control circuit according to claim 1, wherein the inductor current exhibits both positive peak values and negative peak values during each switching cycle.

4. The ZVS soft switching control method for the power control circuit according to claim 1, wherein two of the trapezoidal waveforms which are adjacent have different average current values.

5. The ZVS soft switching control method for the power control circuit according to claim 1, wherein each of the trapezoidal waveforms sequentially has three stages, and middle of the stages is flattest.

6. The ZVS soft switching control method for the power control circuit according to claim 1, wherein an output voltage contains a level sequence of “(x+1), x, (x−1)” or “−(x+1), −x, −(x−1)”, and x is a positive integer.

7. The ZVS soft switching control method for the power control circuit according to claim 6, wherein x is changed to adjust the inductor current.

8. The ZVS soft switching control method for the power control circuit according to claim 1, wherein an output voltage contains a level sequence of “N, x, 0” or “−N, −x, 0”, N is a maximum number of positive voltage levels, and x is a positive integer.

9. The ZVS soft switching control method for the power control circuit according to claim 8, wherein x is changed to adjust the inductor current.

10. The ZVS soft switching control method for the power control circuit according to claim 1, wherein an output voltage contains different duty cycles for different switch cycles.

11. The ZVS soft switching control method for the power control circuit according to claim 10, wherein the duty cycles are continuously changed to adjust the shape of the inductor current.

12. The ZVS soft switching control method for the power control circuit according to claim 1, further comprising:
executing a capacitor voltage balancing control to maintain a capacitor voltage.

13. The ZVS soft switching control method for the power control circuit according to claim 1, wherein the inductor current with the trapezoidal waveforms is modulated based on a level sequence of an output voltage, a plurality of duty cycles and a switching frequency.

14. A power control circuit, comprising:
a trapezoidal current control unit, configured to shape an inductor current into a plurality of trapezoidal waveforms.

15. The power control circuit according to claim 14, further comprising:
an average current control unit, configured to make the inductor current has a sinusoidal average current value.

16. The power control circuit according to claim 14, wherein the inductor current exhibits both positive peal values and negative peak values during each switching cycle.

17. The power control circuit according to claim 14, wherein two of the trapezoidal waveforms which are adjacent have different average current values.

18. The power control circuit according to claim 14, wherein each of the trapezoidal waveforms sequentially has three stages, and middle of the stages is flattest.

19. The power control circuit according to claim 14, wherein an output voltage contains a level sequence of “(x+1), x, (x−1)” or “−(x+1), −x, −(x−1)”, and x is a positive integer.

20. The power control circuit according to claim 19, wherein x is changed to adjust the inductor current.

21. The power control circuit according to claim 14, wherein an output voltage contains a level sequence of “N, x, 0” or “−N, −x, 0”, N is a maximum number of positive voltage levels, and x is a positive integer.

22. The power control circuit according to claim 21, wherein x is changed to adjust the inductor current.

23. The power control circuit according to claim 14, wherein an output voltage contains different duty cycles for different switch cycles.

24. The power control circuit according to claim 23, wherein the duty cycles are continuously changed to adjust the shape of the inductor current.

25. The power control circuit according to claim 14, further comprising:
a capacitor voltage balancing control unit, configured to maintain a capacitor voltage.

26. The power control circuit according to claim 14, wherein the inductor current with the trapezoidal waveforms is modulated based on a level sequence of an output voltage, a plurality of duty cycles and a switching frequency.

27. The power control circuit according to claim 14, wherein the power control circuit is an AC-DC converter or a DC-AC converter.
